(19) United States
(12) Patent Application Publication
(10) Pub. No.: US 2022/0312755 A1
(43) Pub. Date: Oct. 6, 2022

(54) DEVICE FOR AFFIXING MOSQUITO LARVICIDE IN RAIN GUTTERS

(71) Applicant: Robert Michael Simon, Livington, NJ (US)

(72) Inventor: Robert Michael Simon, Livington, NJ (US)

(21) Appl. No.: 17/480,142

(22) Filed: Sep. 21, 2021

Related U.S. Application Data
(60) Provisional application No. 63/080,773, filed on Sep. 20, 2020.

(51) Int. Cl. A01M 1/20; E04D 13/064

(52) U.S. Cl. CPC A01M 1/20; E04D 13/064; A01M 2200/012

(57) ABSTRACT

A device that confines a water soluble larvicide or insecticide or other solid or semi-solid chemical medium that allows for a measured dispersal with a means for affixing to a rain gutter or open water container susceptible to harbor or breed mosquito larvae.

### FIELD

The present application relates to a device with a mesh pouch, in particular one that confines a solid or semi-solid larvicide, insecticide or chemical with a means for attaching to a water container or rain gutter.

### BACKGROUND

Mosquitoes are known to breed in any and all outdoor items that can hold water that is allowed to stagnate for 2 or more days. While the simple procedure to not allow for standing water is to simply empty these items of any standing water.

Rain Gutters are the most overlooked, untreated, mosquito breeding grounds.

Mosquitoes are known carriers of many diseases harmful to both human and animal life Mosquito-borne diseases include:

### Brain Inflamation (Encephalitis-Causing Viruses)

West Nile, Eastern equine Encephalitis, La Crosse encephalitis, Saint Louis encephalitis, Chikungunya, Cache Valley, Jamestown Canyon Cache Valley, Tensaw, Zika Virus

### Internal Bleeding (Hemorrhagic Viruses)

Dengue, Yellow fever

### Parasites

Worms (filarial nematodes), Filariasis, Heartworm (Dog, Cat and Ferret)

### Single-Celled-Parasites

Malaria

Rain gutters on buildings and homes do not always drain properly or should a small amount of debris collect in said rain gutters, water will remain resulting in a standing water situation.

Rain gutters are not easily accessible to place a Larvicide or Insecticide in each rain gutter after each rainfall to prevent the breeding of mosquitoes. Larvicide or insecticide or other solid or semi-solid chemical medium placed in the rain gutter needs to be dissolved and be in solution in the entire length of the rain gutter to be effective. any precipitation will wash the larvicide or insecticide towards the downspout where it will exit the rain gutter so only untreated rainwater will remain, rendering any treatment useless, unless retreated after each subsequent rainfall.

For one such example there are products that contain Bti, a biological or a naturally occurring bacterium found in soils. (Bti is short for Bacillus thuringiensis subspecies israelensis) that will kill mosquito larvae effectively in stagnant water situations and is not harmful to other forms of life.

The products that contain Bti are normally blocks or small bits or pieces that allow the release of said bacterium into standing water. One such configuration of the Bti is a block in the shape of a small doughnut. This doughnut shaped Larvicide does have a hole in the center that could be tied to the far end of a rain gutter with the opposite end terminating with a downspout or in the center of a rain gutter with 2 or more downspouts. The above mentioned doughnut is a material that floats. Should the doughnut dissolve, break apart or weaken it can detach and will float towards the downspout and be flushed away rendering it ineffective.

Attempting to tie the above mentioned doughnut to the proper location in an elevated rain gutter can be dangerous from several standpoints. Standing on the edge of a roof attempting to tie something to the rain gutter can result in a fall. Standing on a tall ladder also presents itself to be hazardous as falls from ladders can seriously injure the user. The longer the time spent on a ladder the more the chances multiply for the user to fall should the ladder be not positioned properly or the user is not familiar with the proper usage of said ladder.

There are many devices that utilize a mesh of varying materials to contain different articles.

U.S. Pat. No. 2,958,885 CLEANING IMPLEMENT shows a sealed mesh pouch containing a sponge. This device while utilizing a mesh material with, is a sealed, non-refillable, pouch, intended for scrubbing a surface.

U.S. Pat. No. 2,817,865 SPONGE COVERED STRAND WASH CLOTH WITH SOAP POCKET shows a mesh refillable bar soap holder with large openings for the soap to dissolve not suitable for proper timed released dissolution of a larvicide, insecticide or other water soluble chemical. While it does have a loop attached for hanging, it does not allow for secure attachment to a rain gutter or other open water container.

U.S. Pat. No. 5,092,682 TRANSPORTABLE SHOWER BAG shows another mesh bag, again without a specific mesh open area suitable for dissolution of a larvicide or insecticide in a rain gutter of other open water container.

Other patents that make claim for utilizing a mesh material with different purposes in mind are:
U.S. Pat. No. 1,749,776 Ham bag
U.S. Pat. No. 2,457,918 Soap container Mesh with suction cup
U.S. Pat. No. 2,511,644 Mesh Laundry Bag
U.S. Pat. No. 2,804,898 Laundry Bag
U.S. Pat. No. 3,074,452 Shower Utility bag with clips
U.S. Pat. No. 3,231,901 Hospital Drain Bag Hanger
U.S. Pat. No. 4,228,834 Mesh Hanging Soap Bag
U.S. Pat. No. 1,906,500 Mesh Bag

None of the above referenced inventions are suitable for the needs of the present invention.

There is a need for a device that can be safely filled on the ground, which can be secured to a rain gutter easily, effectively, and safely with minimal time involved. This device effectively tethers the larvicide, insecticide or other solid or semi-solid chemical medium to one specific location that can be easily located for replenishment. This device provides for full time protection and elimination of mosquito larvae in the most overlooked, under treated, mosquito breeding area that can last for many months without replenishing.

### SUMMARY

The present invention relates to a mesh pouch, specifically designed to contain a mosquito larvicide or insecticide or other solid or semi-solid chemical medium that slowly dissolves and maintain its position at the far end of a rain gutter or open water container such as a fish pond.

The pouch is closed on 3 sides and a weather resistant spring loaded clip closes the open side, confining the bulk of the mosquito larvicide or insecticide or chemical medium within said pouch. Attached to the clip is an interconnecting loop that connects to a hook. This hook attaches to a rain gutter or an open water container, keeping the entire assembly in place to increase the efficacy of the larvicide or mosquito insecticide and allow easy locating for future replenishing.

With respect to the use in a rain gutter, this pouch allows the larvicide to cycle, through wet and dry periods and afford a longer useful life of 5 or more months of active water treatment as opposed to 7-14 days of granular filled packets or blocks that can float away.

What remains in the rain gutter effectively treats any remaining standing water with a fresh dissolution of larvicide, insecticide or other chemical medium that will prevent any mosquito larvae from living past its larval stage, reducing the local mosquito population.

### BRIEF DESCRIPTION OF DRAWINGS

FIG. 1 is a perspective view of one embodiment of the larvicide containment device placed in a typical rain gutter.

FIG. 2 is a frontal view of the device

FIG.3 is an elevated side view of the device

FIG.4 is a magnified view of the mesh used in one embodiment of the device

### DETAILED DESCRIPTION

The Device for Affixing Mosquito Larvicide In Rain Gutters, known as the Present Invention or herein as The Device will be described by the embodiments. It is also known as of this writing that The Device can be utilized to hold a larvicide, insecticide or other water soluble solid or semi-solid chemical larvicide medium, further referred to as the solids 8, within the said device to allow for a metered dissolution of the inserted solids 8 in a rain gutter or other water container, e.g a bucket, or in ground fish pond.

FIG.1 represents the present invention installed within the confines of a section of a house rain gutter 9 located at an end opposite the downspout or the section of said rain gutter where the accumulated rain water exits the rain gutter.

The Device is hooked onto the edge of the rain gutter 10 and allowed to sit within the confines or the rain gutter 9. The hook 7, maintains the position of the device at the area furthest from the downspout where the treated water will exit the rain gutter. The loop 6 acts as the intermediary connection of the hook 7 to the clip 5. Loop 6 also and acts as a swivel and allows for the pouch 1 to be able to be aligned with the bottom of rain gutter 9. Clip 5 not only holds the mesh pouch 1 securely to the hook, loop and clip apparatus 5 6 7, it also acts to close the mesh pouch 1 containing the solids 8.

As water travels down the roof 11 towards and into the rain gutter, water washes through the mesh 1 FIG. 4 dissolving the enclosed solids 8, where a metered dissolution of the solids, due to the proper open dimensions of the mesh 1 FIG.4 13 enter into the rain gutter 9 and will remain in any standing water when the rainfall has ceased. The properly diluted solids 8 are now in solution in the case of any adult female mosquito laying eggs in the stagnant water. The mosquito eggs will hatch in several days releasing the mosquito larvae into the stagnant water. The mosquito larvae will consume the Bti or insecticide, effectively killing the larvae before becoming an adult mosquito, thus preventing the rain gutters from becoming a mosquito breeding ground.

Mosquitoes will cease to lay eggs once the water has evaporated, or until the next rain cycle when more solids 8 will be delivered in solution to the rain gutter 9 and the above cycle repeats.

The Device shows the mesh pouch 1 as either as two sheets of mesh 1 FIG. 4, or a single sheet of mesh 1 FIG. 4 folded on line 2 to form the beginnings of an envelope. The edges 3 are sealed using any of numerous methods. These methods can be heat applied to weld the plastic coating on the mesh, sonic welded, or sewn, or glued to seal the three edges.

The opening 4 remains unsealed to allow for the replenishment or replacement of the solids 8.

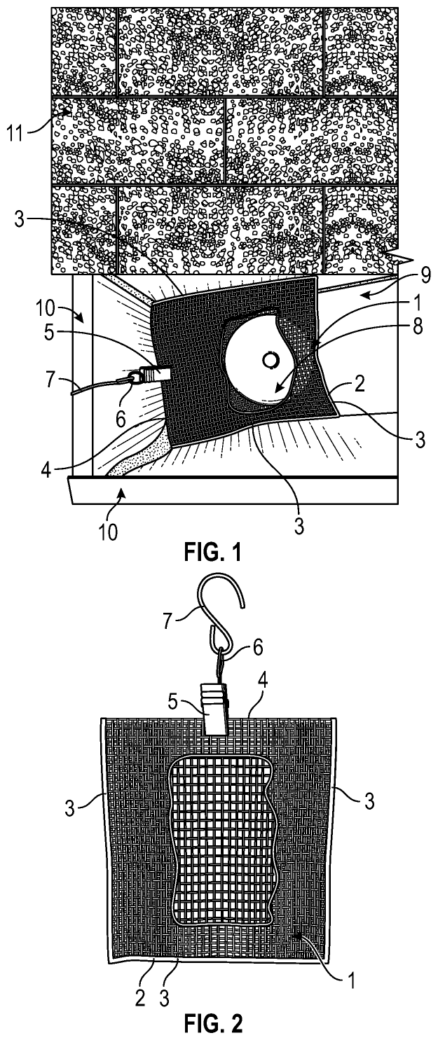

FIG. 2 shows The Device from a frontal view showing the device in its entirety. The double sided pouch 1, the fold 2 and the welded, sewn, glued, closed seams 3. Opening 4 is closed using clip 5 which attaches to loop 6 and in turn attaches to hook 7.

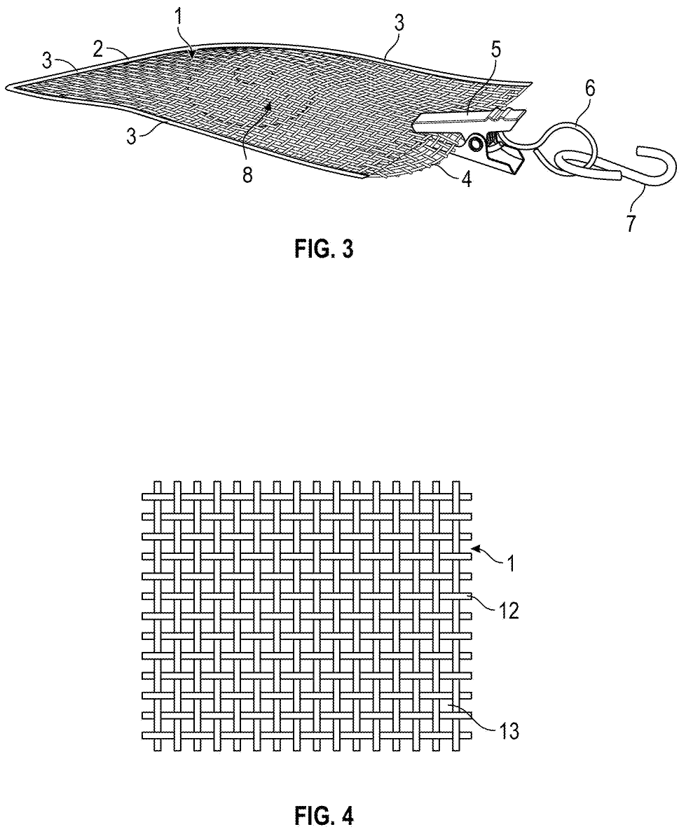

FIG.3 shows an elevated side view of The Device showing an alternate view of the mesh pouch 1 the folded seam 2, the welded seams 3. The opening 4 is being held closed with clip 5. Clip 5 is attached to hook 7 using the swivel loop 6, Inside the mesh pouch 1 is a double circle indicative of the round solid 8.

FIG. 4 shows a magnified view of the Mesh 1. An important feature of the mesh 1 is that the strands 12 are of a certain diameter, consisting of a coated fiber e.g polyester, glass, carbon with a coating that can be sewn, glued, heat or sonic welded e.g. vinyl, polyvinylchloride, EPDM rubber (ethylene propylene diene monomer rubber). Additional importance is the dimensions of the openings 13 of the mesh 1 that allow the proper dissolution of the solids 8.

1. A device comprising of a mesh pouch with a clip, loop and hook attachment.

2. A device according to claim 1, comprised of a mesh pouch that is sealed on 3 sides.

3. A device according to claim 1 comprised of a mesh pouch that has one open side.

4. A device according to claim 3 comprised of a clip that secures the open side.

5. A device according to claim 1 where the clip is attached to a swivel loop and attaches to a hook.

6. A device according to claim 5 where the hook is a means for attaching the device to a structure that contains water that is also allowed to drain.

7. A device according to claim 1 comprises a clip, loop and hook of weather resistant materials.

8. A device according to claim 1 comprises a mesh pouch that contains a larvicide, insecticide or other water soluble solid or semi-solid chemical.

9. A device according to claim 1 that is comprised of a mesh with strands that measure approximately 0.025 inch in diameter.

10. A device according to claim 7 that the mesh is comprised of strands of woven polyester, glass or carbon filaments coated with an ultraviolet resistant, weather resistant flexible poly vinyl chloride heat/thermal/sonic sealable coating or EPDM rubber (ethylene propylene diene monomer rubber)

11. A device according to claim 10 that is comprised of a mesh that is also able to have the seams sealed by sewing, gluing, cementing, taping or chemical welds.

12. A device according to claim 7 that comprises a mesh opening size of approximately 0.85 mm x 1.9 mm. that allows for water to flow through the mesh to slowly dissolve and dispense/disperse the contents.

13. A device according to claim 7 that allows the metered dissolution of said larvicide, insecticide or water soluble solid or semi-solid chemical as water passes through the mesh and into the container it is attached to.

14. A device according to claim 12 that allows the contained materials to dry in between water wetting cycles.
